(19) United States
(12) Patent Application Publication
(10) Pub. No.: US 2026/0138483 A1
(43) Pub. Date: May 21, 2026

(54) CHARGING CONTROL DEVICE AND CHARGING SYSTEM FOR VEHICLE

(71) Applicant: TOYOTA JIDOSHA KABUSHIKI KAISHA, Toyota-shi (JP)

(72) Inventor: Tatsuya FUJII, Nagakute-shi (JP)

(73) Assignee: TOYOTA JIDOSHA KABUSHIKI KAISHA, Toyota-shi (JP)

(21) Appl. No.: 19/364,497

(22) Filed: Oct. 21, 2025

(30) Foreign Application Priority Data
Nov. 20, 2024 (JP) 2024-202234

(51) Int. Cl. B60L 53/62; B60L 53/51; B60L 53/64; B60L 53/68; B60L 55/00

(52) U.S. Cl. CPC B60L 53/62; B60L 53/51; B60L 53/64; B60L 53/68; B60L 55/00; B60L 2240/545

(57) ABSTRACT

A charging/discharging device is configured to perform V2X charging/discharging with a charging/discharging station. A server makes a V2X charging/discharging plan for charging a battery by the charging/discharging device such that an SOC of the battery is equal to a target SOC. The server predicts a temperature of the battery when V2X charging/discharging is performed next time by the charging/discharging device. When the predicted temperature of the battery during the next V2X charging/discharging is low, the server formulates (updates) the V2X charging/discharging plan by setting the target SOC higher than the target SOC when the predicted temperature is high.

This nonprovisional application is based on Japanese Patent Application No. 2024-202234 filed on Nov. 20, 2024 with the Japan Patent Office, the entire contents of which are hereby incorporated by reference.

### BACKGROUND

### Field

The present disclosure relates to a charging control device for a vehicle and a charging system including the same.

### Description of the Background Art

Japanese Patent Laying-Open No. 2020-68568 describes an electrically powered vehicle in which a vehicle-mounted secondary battery is charged from a system power supply (external charging), and the vehicle is driven by a motor generator using electric power stored in the battery. In this vehicle, the lower the temperature of the battery, the smaller the charging current of the battery.

In the above publication, since the charging current of the battery is reduced at a low temperature, it takes time to perform external charging, and there is a possibility that the battery cannot be sufficiently charged. If the battery is not sufficiently charged and the SOC (State Of Charge) is low, the output of the battery is suppressed. In addition, the output of the battery itself is suppressed even at a low temperature. Therefore, under a low temperature, during traveling after external charging (for example, after the start of traveling), the output of the battery is significantly suppressed, and there is a possibility that the traveling performance of the vehicle is significantly deteriorated.

### SUMMARY

The present disclosure is made to solve such a problem, and an object of the present disclosure is to provide a charging control device and a charging system for a vehicle that can prevent significant deterioration of the traveling performance while the vehicle is traveling after external charging.

A charging control device according to the present disclosure is a charging control device for a vehicle, and the vehicle includes a battery that stores electric power for traveling, a driving device, and a charging device. The driving device generates a driving force for the vehicle using electric power stored in the battery. The charging device charges the battery with a power supply external to the vehicle (external charging). The charging control device includes a processor and a memory that stores a program to be executed by the processor. In accordance with the program, the processor makes a charging plan for charging the battery by the charging device such that an SOC of the battery is equal to a target SOC, and predicts a temperature of the battery when the battery is charged next time by the charging device. When the predicted temperature of the battery when being charged next time is low, the processor makes the charging plan by setting the target SOC higher than the target SOC when the predicted temperature is high.

In this charging control device, a charging plan is made such that the SOC of the battery is equal to a target SOC. The temperature of the battery when the battery is charged next time is predicted and, when the predicted temperature is low, the charging plan is made by setting the target SOC higher than the target SOC when the predicted temperature is high. Accordingly, the SOC is increased for the current charging based on the charging plan, and therefore, the SOC after the next charging can be ensured even when the charging amount when the battery is charged next time is reduced due to a low temperature. Thus, it is possible to prevent significant deterioration of the traveling performance during traveling after the next external charging.

When discharge power of the battery is limited to a predetermined value or less due to a decrease in the temperature of the battery, the processor may make the charging plan by setting the target SOC to a higher value.

When the discharge power is limited to the predetermined value or less due to a decrease in the temperature of the battery, the processor may make the charging plan by increasing the target SOC set by a user of the vehicle.

The processor may predict the temperature of the battery during charging to be performed next time by the charging device.

The processor may make the charging plan such that charging of the battery has been completed at a set travel start time of the vehicle, and predict the temperature, at the travel start time, of the battery after being charged next time by the charging device.

A charging system according to the present disclosure is a charging system used for charging a vehicle, and includes a charging facility to which the vehicle is to be connected, and a charging control device for the vehicle. The vehicle includes a battery that stores electric power for traveling, a driving device, and a charging device. The driving device generates a driving force for the vehicle using electric power stored in the battery. The charging device charges the battery with electric power supplied from the charging facility (external charging). The charging control device makes a charging plan for charging the battery by the charging facility such that an SOC of the battery is equal to a target SOC, and predicts a temperature of the battery when the battery is charged next time by the charging facility. When the predicted temperature of the battery is low, the charging control device makes the charging plan by setting the target SOC higher than the target SOC when the predicted temperature of the battery is high. The charging facility charges the battery in accordance with the charging plan made by the charging control device.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an overall configuration of an energy management system according to an embodiment of the present disclosure.

FIG. 2 is a diagram showing discharge characteristics of a battery.

FIG. 3 is a timing chart when a target SOC is changed.

FIG. 4 is a flowchart illustrating a process performed by a server regarding V2X charging/discharging.

FIG. 5 is a flowchart illustrating a process executed by a server according to a first modification.

FIG. 6 is a flowchart illustrating a process executed by a server according to a second modification.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

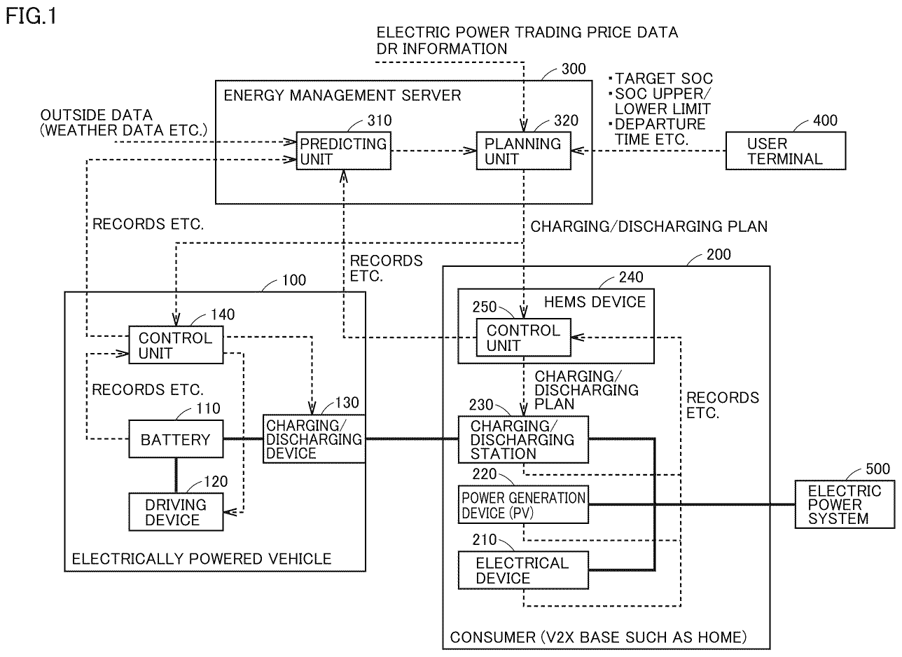

FIG. 1 is a diagram illustrating an overall configuration of an energy management system according to an embodiment of the present disclosure. Referring to FIG. 1, the energy management system (hereinafter, this will be referred to as “EMS (Energy Management System)”) includes an electrically powered vehicle 100, a consumer facility 200, an energy management server (hereinafter, it is simply referred to as a “server”) 300, and a user terminal 400.

In the EMS, electric power can be exchanged between the electrically powered vehicle 100 and the consumer facility 200. Hereinafter, the exchange of electric power between the electrically powered vehicle 100 and the consumer facility 200 is referred to as “V2X charging/discharging”.

The V2X charging/discharging is planned by the server 300 based on the supply/demand situation of the electric power system 500, the implementation request of the DR in the case of participating in the demand response (DR), the power trade price, the power supply/demand situation of the consumer facility 200, the usage situation of the electrically powered vehicle 100, the charging/discharging capability of the electrically powered vehicle 100, the amount of electric power stored in the electrically powered vehicle 100, various settings by the user, and the like.

The electrically powered vehicle 100 is a vehicle that can travel using electric power stored in a battery, and is, for example, an electric vehicle (BEV: Battery Electric Vehicle), a plug-in hybrid vehicle (PHEV: Plug-in Hybrid Electric Vehicle), or the like. Hereinafter, the electrically powered vehicle 100 is referred to as a BEV.

Electrically powered vehicle 100 includes a battery 110, a driving device 120, a charging/discharging device 130, and a control unit 140. The battery 110 is a power storage element configured to be chargeable and dischargeable, and includes, for example, a secondary battery such as a lithium ion battery or a nickel-metal hydride battery. The battery 110 stores electric power for generating the travel driving force by the driving device 120, and supplies the stored electric power to the driving device 120. In addition, the battery 110 can store regenerative electric power generated by the driving device 120 during braking of the vehicle.

Further, the battery 110 can be electrically connected to a charging/discharging station 230 (described later) provided in the consumer facility 200 through the charging/discharging device 130, and can exchange electric power with the charging/discharging station 230 (the consumer facility 200) (V2X charging/discharging).

The driving device 120 generates a traveling driving force of the electrically powered vehicle 100. The driving device 120 is configured to include a motor generator that generates a traveling driving force and an inverter that drives the motor generator (both are not shown). The inverter is provided between the battery 110 and the motor generator. A converter may be provided between the inverter and the battery 110. During braking of the electrically powered vehicle 100, the motor generator generates electric power by the rotational force of the drive wheels, and the generated electric power (regenerative electric power) can be stored in the battery 110.

Charging/discharging device 130 is a device for electrically powered vehicle 100 to perform V2X charging/discharging. The charging/discharging device 130 includes an inlet to which a connector provided on a power cable of the charging/discharging station 230 can be connected, a relay that is closed during V2X charging/discharging, and a charging/discharging device (neither of which are shown). When the battery 110 is charged from the charging/discharging station 230, the charger/discharger converts electric power supplied from the charging/discharging station 230 into electric power capable of charging the battery 110. On the other hand, when power is supplied from the battery 110 to the charging/discharging station 230, the charging/discharging device converts power discharged from the battery 110 into power that can be supplied to the consumer facility 200. The charger/discharger is constituted by, for example, an AC/DC converter. Note that the charging/discharging device may be provided on the charging/discharging station 230 side.

The control unit 140 is configured to include a processor such as a CPU (Central Processing Unit), a memory (ROM (Read Only Memory) and RAM (Random Access Memory)), and a signal buffer for inputting and outputting various signals (all not shown). The control unit 140 controls the driving device 120 to execute various processes for realizing traveling of the electrically powered vehicle 100. The control unit 140 calculates the SOC of the battery 110. The SOC can be calculated by various known methods.

Further, the control unit 140 receives a V2X charging/discharging plan formulated by the server 300 from the server 300. Then, when the connector of the charging/discharging station 230 is connected to the charging/discharging device 130, the control unit 140 controls the charging/discharging device 130 according to the V2X charging/discharging plan to perform V2X charging/discharging with the charging/discharging station 230 of the consumer facility 200.

The consumer facility 200 is electrically connected to the electric power system 500 and can exchange electric power with the electric power system 500. The consumer facility 200 is, for example, a home or the like of an owner of the electrically powered vehicle 100. The consumer facility 200 includes an electrical device 210, a power generation device 220, a charging/discharging station 230, and a HEMS (Home Energy Management System) device 240.

The electrical devices 210 are various electrical loads in the consumer facility 200. The power generation device 220 is a facility capable of generating power in the consumer facility 200, and is, for example, a PV (Photovoltaic) device. The charging/discharging station 230 is a facility for the electrically powered vehicle 100 to perform V2X charging/discharging with the consumer facility 200, and is electrically connected to the electrically powered vehicle 100 through the charging/discharging device 130 of the electrically powered vehicle 100.

The charging/discharging station 230 is electrically connected to the electric power system 500, the electrical device 210, and the power generation device 220. When electrically powered vehicle 100 is connected, charging/discharging station 230 can supply electric power from electric power system 500 or power generation device 220 to electrically powered vehicle 100 to charge battery 110 of electrically powered vehicle 100 (V2X charging). On the other hand, the charging/discharging station 230 can supply electric power supplied (discharged) from the electrically powered vehicle 100 to the electrical device 210 or the electric power system 500 (V2X discharging).

The HEMS device 240 is a device for managing various electric facilities and power of the consumer facility 200. The HEMS device 240 manages operations of the electrical device 210, the power generation device 220, and the charging/discharging station 230, and power in the consumer facility 200. The HEMS device 240 includes a control unit 250.

The control unit 250 includes a processor such as a CPU, a memory (a ROM and a RAM), and a signal buffer for inputting and outputting various signals (both are not shown). The control unit 250 manages the electric power in the consumer facility 200 by controlling the electrical device 210 and the power generation device 220.

Further, the control unit 250 receives the V2X charging/discharging plan formulated by the server 300 from the server 300. Then, when the electrically powered vehicle 100 is connected to the charging/discharging station 230, the control unit 250 controls the charging/discharging station 230 according to the V2X charging/discharging plan, and performs V2X charging/discharging between the electrically powered vehicle 100 and the charging/discharging station 230 in cooperation with the electrically powered vehicle 100.

The server (charging control device) 300 executes various processes for formulating a plan of V2X charging/discharging by the electrically powered vehicle 100. The server 300 includes a processor such as a CPU, a memory (a ROM and a RAM), and a signal buffer for inputting and outputting various signals (both are not shown). The processor loads a program stored in the ROM into the RAM and executes the program. Various processes executed by the server 300 are described in the program stored in the ROM.

The server 300 includes a predicting unit 310 and a planning unit 320. The predicting unit 310 executes processing for predicting a future charging/discharging amount by the V2X charging/discharging. Specifically, the predicting unit 310 acquires weather data and the like of the area of the consumer facility 200 from an external server (not illustrated). The weather data is weather forecast information of the region, and includes forecast information such as weather, temperature, and amount of solar radiation for each time period. In this embodiment, weather data of the next day or later (at least up to the next day) is acquired. In addition, the predicting unit 310 acquires the record information of the V2X charging/discharging from the electrically powered vehicle 100 and the consumer facility 200 at the time of executing the V2X charging/discharging. The record information includes, for example, a time during which the V2X charging/discharging is performed, information of power charged/discharged by the V2X charging/discharging, SOC information of the battery 110, and the like.

Then, the predicting unit 310 predicts a future charging/discharging amount by the V2X charging/discharging from the acquired weather data and the record information of the V2X charging/discharging. Various logics can be applied to the prediction logic of the V2X charging/discharging. For example, the predicting unit 310 predicts a time period in which the electrically powered vehicle 100 can be connected to the charging/discharging station 230 from the record information of the V2X charging/discharging. Then, the predicting unit 310 predicts the amount of charge by the V2X charge when the predicted time period is a time period in which the amount of solar radiation is predicted to be large, a midnight time period in which the electric power fee is inexpensive, or the like, and predicts the amount of discharge by the V2X discharging when the predicted time period is a peak time period of the electric power system 500, a time period in which the load of the electrical device 210 is high, or the like.

The planning unit 320 formulates a plan of V2X charging/discharging by the electrically powered vehicle 100. Specifically, the planning unit 320 acquires, from an external server (not shown), electric power trading price data in the power trading market and information on the DR when participating in the DR. In addition, the planning unit 320 acquires, from the user terminal 400, various settings of the V2X charging/discharging by the user (the owner of the electrically powered vehicle 100, the administrator of the consumer facility 200, or the like).

The user can instruct various settings related to V2X charging/discharging from the user terminal 400. Specifically, the user can set the target SOC of the battery 110 at the end of the V2X charging/discharging, the SOC upper limit value and the SOC lower limit value of the battery 110, the departure time of the electrically powered vehicle 100 after the V2X charging/discharging, and the like from the user terminal 400. Note that various settings are applied to each V2X charging/discharging unless otherwise changed. Each setting value input in the user terminal 400 is transmitted from the user terminal 400 to the server 300.

Then, the planning unit 320 formulates a V2X charging/discharging plan using the charging/discharging amount of the V2X charging/discharging predicted by the predicting unit 310, each setting value from the user terminal 400, the electric power trading price data and the DR information acquired from the external server, and the like. Various logics can be applied to the charging/discharging plan formulation logic, and for example, a V2X charging/discharging plan capable of realizing the predicted charging/discharging amount as much as possible while responding to the DR request is formulated from the viewpoint of economic optimum (cost optimum) using each setting value (departure time, target SOC, SOC upper limit value, SOC lower limit value, and the like) from the user terminal 400 as a constraint condition.

As described above, the electrically powered vehicle 100 can charge the battery 110 with electric power supplied from the charging/discharging station 230 of the consumer facility 200 (V2X charging). Here, since the charging current of the battery 110 is reduced from the viewpoint of battery protection at a low temperature, V2X charging takes time, and there is a possibility that the battery 110 cannot be sufficiently charged. When the battery 110 is not sufficiently charged and the SOC is low, the output of the battery 110 is suppressed. In addition, the output of the battery 110 itself is suppressed even at a low temperature. Therefore, under a low temperature, during traveling after V2X charging (for example, after the start of traveling), the output of the battery 110 is significantly suppressed, and there is a possibility that the traveling performance of the electrically powered vehicle 100 is significantly degraded.

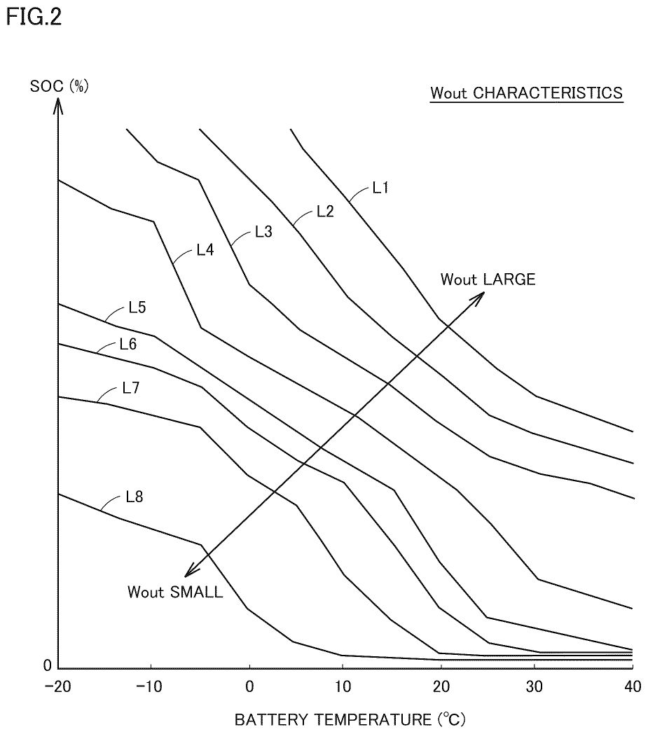

FIG. 2 is a diagram illustrating discharge characteristics of the battery 110. In FIG. 2, the horizontal axis indicates the temperature of the battery 110, and the vertical axis indicates the SOC of the battery 110.

Referring to FIG. 2, lines L1 to L8 indicate contour lines of discharge limit Wout (kW) indicating the upper limit of the discharge power of battery 110, and Wout sequentially decreases from line L1 toward line L8. The discharge limit Wout is provided from the viewpoint of battery protection, and the current of the battery 110 is controlled so that the discharge power of the battery 110 does not exceed the discharge limit Wout.

Lines L1 to L8 indicate the discharge limit Wout for each temperature and SOC of the battery 110. As shown, the lower the temperature of the battery 110 and the lower the SOC of the battery 110, the lower the discharge limit Wout. That is, when the SOC is low at a low temperature, the discharge limit Wout is largely limited.

As described above, the discharge limit Wout becomes small at a low temperature (particularly, at an extremely low temperature). In addition, although not particularly illustrated, since the charging limit Win (kW) indicating the upper limit of the charging power of the battery 110 also becomes small at a low temperature, there is a possibility that the battery 110 is not sufficiently charged by the V2X charging and the SOC is low even after the V2X charging. Therefore, the discharge limit Wout is largely limited under a low temperature. When the discharge limit Wout is greatly limited, the traveling performance of the electrically powered vehicle 100 is greatly reduced. Such a situation may occur when V2X charging is performed under low temperature.

Therefore, in the present embodiment, when the plan of the V2X charging/discharging (for the current time) is formulated, the temperature of the battery 110 at the time of the next V2X charging/discharging is predicted, and when the predicted temperature falls below the threshold value and thus the discharge limit Wout of the next V2X charging/discharging is largely limited (for example, several tens of kW or less), the target SOC of the battery 110 by the current V2X charging/discharging is increased. In the present embodiment, as described above, the target SOC by the V2X charging/discharging is set by the user from the user terminal 400, but the target SOC set by the user is increased. For example, by using the relationship shown in FIG. 2, the target SOC is increased to an SOC in which the discharge limit Wout exceeds a predetermined value (for example, several tens of kW) at the above-described predicted temperature.

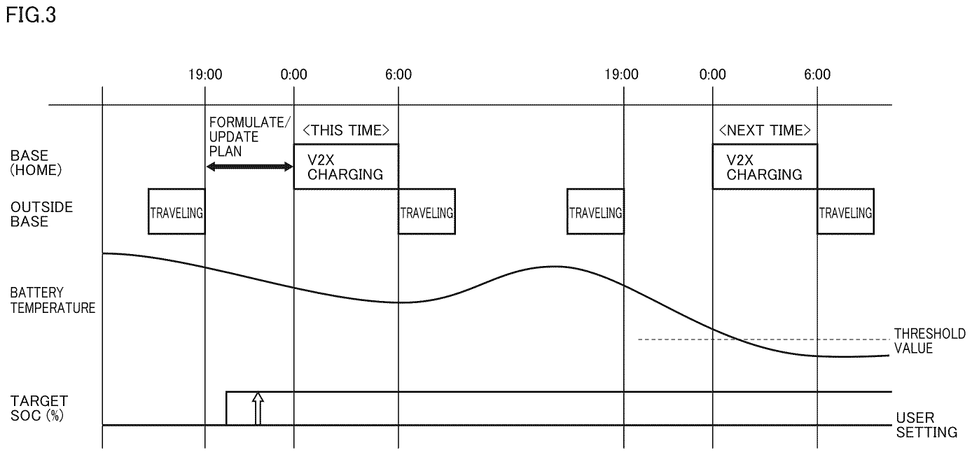

FIG. 3 is a timing chart when a target SOC is changed. Referring to FIG. 3, in this example, electrically powered vehicle 100 is used for commuting from around 6 o'clock on weekdays, and electrically powered vehicle 100 is also used when returning home at around 19 o'clock. Then, every night, the V2X charging/discharging is performed from about 0 o'clock to the travel start time (about 6 o'clock) of the next day. In this time period, the power price is low because of the midnight, and the load of the electrical device 210 of the consumer facility 200 is also low, so that the plan of the V2X charging in which the battery 110 is charged is formulated.

The V2X charging/discharging plan is formulated before the V2X charging/discharging is started. As described above, the planning unit 320 of the server 300 formulates the V2X charging/discharging plan based on the charging/discharging amount predicted by the predicting unit 310, the setting values (departure time, target SOC, SOC upper limit value, and the like) from the user terminal 400, the electric power trading price data, and the DR information. Hereinafter, planning of the V2X charging indicated as “current time” in FIG. 3 will be described.

The planning unit 320 plans the execution period of the V2X charging based on the departure time of the electrically powered vehicle 100 after the completion of the V2X charging, which is set from the user terminal 400 (in this example, 0 o'clock to 6 o'clock). Here, in this embodiment, the temperature of the battery 110 during the next V2X charging (during charging and after charging) is predicted, and when the predicted temperature falls below a threshold value, the target SOC set by the user is raised from the user terminal 400. The threshold value is a temperature at which the discharge limit Wout of the battery 110 is largely limited, and is set to an appropriate value (for example, −15° C.). Alternatively, from the relationship shown in FIG. 2, the threshold value may be set to a temperature at which the discharge limit Wout is lower than the allowable lower limit (for example, several tens of kW) at a predetermined SOC value (for example, 20%). The target SOC may be raised by adding a predetermined amount (for example, 10 to 15%) to the target SOC set by the user, or by raising the target SOC to an SOC that can obtain the discharge limit Wout (for example, several tens of kW) capable of ensuring the minimum traveling performance at the above-described predicted temperature.

Then, the planning unit 320 re-formulates (updates) the plan of the V2X charging (for this time) using the raised target SOC as a constraint condition (so that the SOC at the end of the V2X charging becomes the target SOC). Then, V2X charging (for this time) is executed according to the updated plan. Accordingly, in a case where the next V2X charge is expected to be performed at a low temperature, the SOC after the current V2X charge is increased, and therefore, even if the charge amount by the next V2X charge decreases at a low temperature, the SOC after the next V2X charge can be secured. Therefore, it is possible to suppress a large decrease in the traveling performance in the traveling after the next V2X charging.

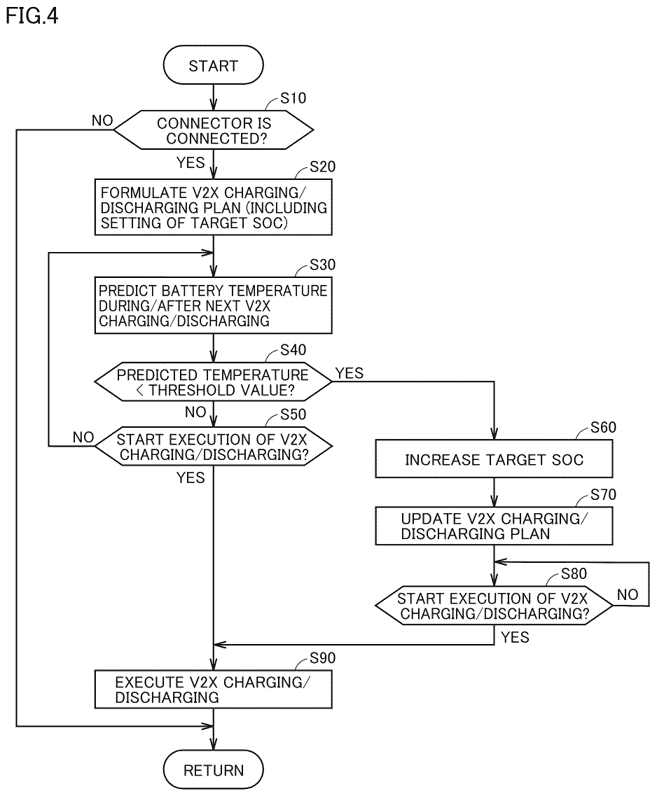

FIG. 4 is a flowchart illustrating processing performed by the server 300 regarding V2X charging/discharging. The series of processing shown in this flowchart is repeatedly executed every predetermined cycle or every time a predetermined condition is satisfied.

Referring to FIG. 4, server 300 determines whether or not the connector of the power cable extending from charging/discharging station 230 of consumer facility 200 is connected to the inlet of charging/discharging device 130 of electrically powered vehicle 100 (step S10). The connection of the connector is detected in the electrically powered vehicle 100 and/or the consumer facility 200, and the server 300 determines the connection of the connector by acquiring the detection result from the electrically powered vehicle 100 and/or the consumer facility 200.

When the connector is not connected to the inlet (NO in step S10), the server 300 proceeds to the return without executing the subsequent series of processes.

When the connector is connected to the inlet (YES in step S10), server 300 formulates a V2X charging/discharging plan (for this time) (step S20). This process includes setting of a target SOC by V2X charging/discharging, a departure time of the electrically powered vehicle 100, and the like from the user terminal 400. Generally speaking, the server 300 predicts the V2X charging/discharging amount from the record of the V2X charging/discharging, the weather data, and the like, acquires each setting value (target SOC, departure time, and the like) from the user terminal 400, and formulates the V2X charging/discharging plan on the basis of the electric power trading price data and the DR information by using these settings as constraint conditions. For example, the plan of the V2X charging/discharging is formulated so that the SOC at the time of the end of the V2X charging/discharging becomes the target SOC and the V2X charging/discharging ends immediately before the departure time of the electrically powered vehicle 100.

Next, the server 300 predicts the temperature of the battery 110 when V2X charging/discharging is performed next time (during/after completion of charging/discharging) (step S30). The “next time” indicates the next V2X charging/discharging after the V2X charging/discharging (current time) for which the plan is formulated in step S20. The timing of the next V2X charging/discharging is predicted from, for example, the setting of the departure time from the user terminal 400 and the past performance of the V2X charging/discharging. The temperature of the battery 110 is appropriately predicted from, for example, a correlation with the temperature at the time of previous V2X charging/discharging and the acquired weather data (temperature prediction).

Next, the server 300 determines whether or not the temperature of the battery 110 predicted in step S30 is lower than a threshold value (step S40). The threshold value is a temperature at which the discharge limit Wout of the battery 110 is largely limited, for example, −15° C., but is not limited thereto.

When the predicted temperature of battery 110 is equal to or higher than the threshold value (NO in step S40), server 300 determines whether or not to start execution of V2X charging/discharging according to the plan formulated in step S20 (step S50). The execution start timing of the V2X charging/discharging is determined in the plan formulation of step S20 based on the departure time of the electrically powered vehicle 100 set from the user terminal 400.

When the execution start time of the V2X charging/discharging has not arrived (NO in step S50), the process returns to step S30. Then, when the execution start time of the V2X charging/discharging arrives (YES in step S50), the V2X charging/discharging is executed according to the plan formulated in step S20 (step S90).

In step S40, when it is predicted that the temperature of battery 110 during the next V2X charging/discharging (during charging/discharging/after completion) becomes lower than the threshold value (YES in step S40), server 300 increases the target SOC of battery 110 (step S60). The target SOC is set by the user terminal 400 (a predetermined default value when there is no user input), and the server 300 raises the target SOC from the setting by the user terminal 400. The target SOC may be raised by a predetermined amount (for example, 10 to 15%), or the target SOC may be raised to an SOC in which the discharge limit Wout exceeds a threshold value (for example, several tens of kW) at the predicted temperature based on the discharge characteristics of the battery 110 shown in FIG. 2.

When the target SOC of the battery 110 is increased, the server 300 updates the V2X charging/discharging plan (for this time) (step S70). Specifically, the V2X charging/discharging plan is formulated again using the changed target SOC as a constraint condition. As a result, the SOC of the battery 110 after the V2X charging (current time) is increased to the target SOC increased in step S60.

Thereafter, when the execution start time of the V2X charging/discharging arrives (YES in step S80), the process proceeds to step S90, and the V2X charging/discharging is executed in accordance with the plan updated in step S70.

As described above, according to this embodiment, when it is expected that the next V2X charge is performed at a low temperature, the SOC after the current V2X charge is increased, so that the SOC after the next V2X charge can be secured even if the charge amount by the next V2X charge decreases at a low temperature. Therefore, it is possible to suppress a large decrease in the traveling performance in the traveling after the next V2X charging.

### First Modification

In the above embodiment, the temperature of the battery 110 after the next V2X charging/discharging is predicted, and when the predicted temperature is lower than the threshold value, the target SOC is increased and the plan of the V2X charging/discharging (for this time) is formulated (updated). In the first modification, when the discharge limit Wout of the battery 110 becomes smaller than the threshold value in response to the predicted temperature of the battery 110 being low, the target SOC is increased and the V2X charging/discharging plan (for this time) is formulated (updated).

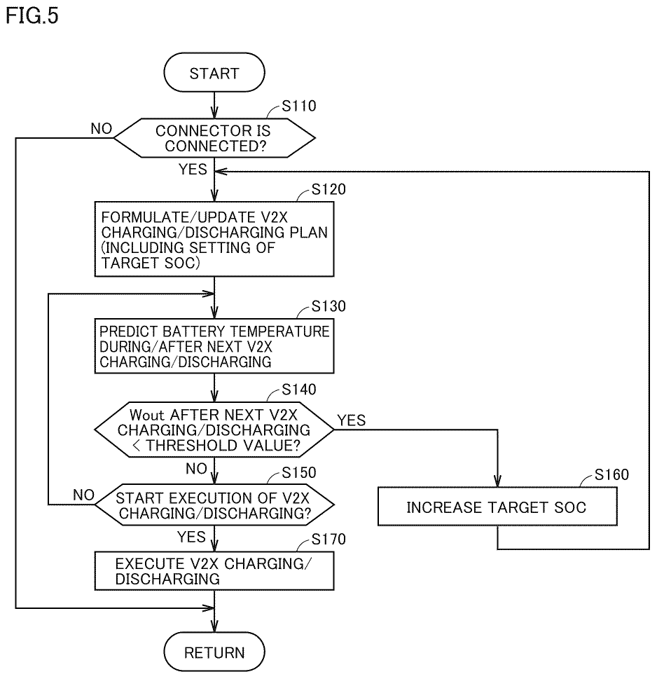

FIG. 5 is a flowchart illustrating processing executed by the server 300 according to the first modification. This flowchart corresponds to the flowchart shown in FIG. 4 in the above embodiment. The series of processing shown in this flowchart is also repeatedly executed every predetermined cycle or every time a predetermined condition is satisfied.

Referring to FIG. 5, the processes of steps S110 to S130 and S150 to S170 are the same as steps S10 to S30, S50, S60, and S90 of FIG. 4, respectively.

In the first modification, when the temperature of the battery 110 at the time of the next V2X charging/discharging (during charging/discharging/end) is predicted in step S130, the server 300 predicts the discharge limit Wout of the battery 110 after the completion of the next V2X charging/discharging based on the predicted temperature and the predicted SOC value of the battery 110 at the time of the end of the next V2X charging/discharging. The SOC prediction value is the target SOC by the V2X charging/discharging or the SOC upper limit value when the SOC upper limit value is lower than the target SOC. Then, the server 300 determines whether or not the predicted value of the discharge limit Wout is smaller than a threshold value (step S140). The threshold value is set to a value (for example, several tens of kW) of the discharge limit Wout that greatly limits the traveling performance of the vehicle.

When discharge limit Wout after the completion of the next V2X charging/discharging is equal to or greater than the threshold value (NO in step S140), server 300 proceeds to the process of step S150.

On the other hand, when it is predicted that discharge limit Wout after the completion of the next V2X charging/discharging becomes smaller than the threshold value (YES in step S140), the process proceeds to step S160, and the target SOC of battery 110 is increased. In the first modification, when the target SOC is increased in step S160, the process returns to step S120, and the V2X charging/discharging plan (for this time) is updated. Specifically, the V2X charging/discharging plan is formulated again using the changed target SOC as a constraint condition. As a result, the SOC of the battery 110 after the completion of the V2X charging (current time) is increased to the target SOC increased in step S160.

As described above, in the first modification, when it is expected that the temperature of the battery 110 is low at the time of the next V2X charge and the discharge limit Wout after the next V2X charge becomes small, the SOC is increased in the current V2X charge, and thus the SOC after the next V2X charge can be secured. Therefore, according to the first modification as well, it is possible to suppress a large decrease in traveling performance during traveling after V2X charging.

### Second Modification

In the above embodiment, as shown in FIG. 4, in step S30, the temperature of the battery 110 at the time of the next V2X charging/discharging (during charging/discharging/after completion) is predicted, but the temperature of the battery 110 at the predicted travel start time after the next V2X charging/discharging may be predicted.

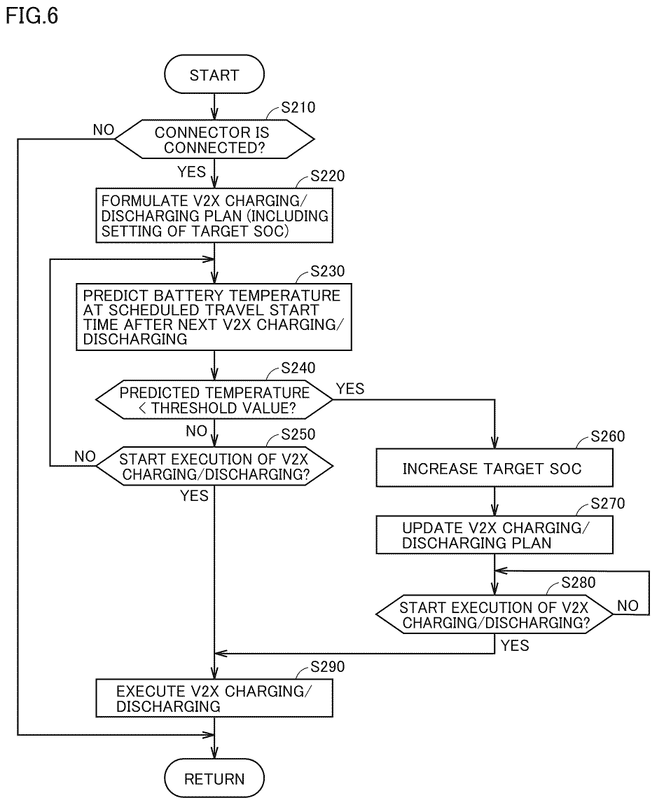

FIG. 6 is a flowchart illustrating processing executed by the server 300 according to the second modification. This flowchart corresponds to the flowchart shown in FIG. 4 in the above embodiment. The series of processing shown in this flowchart is also repeatedly executed every predetermined cycle or every time a predetermined condition is satisfied.

Referring to FIG. 6, steps S210, S220, and S240 to S290 are the same as steps S10, S20, and S40 to S90 of FIG. 4, respectively.

In the second modification, in step S220, when the V2X charging/discharging plan (current time) is formulated, the server 300 predicts the temperature of the battery 110 at the scheduled travel start time of the electrically powered vehicle 100 after the next V2X charging/discharging (step S230). The scheduled travel start time of the electrically powered vehicle 100 is set as a departure time of the electrically powered vehicle 100 by the user terminal 400.

Then, when the temperature of the battery 110 at the scheduled travel start time is predicted, the process proceeds to step S240, and it is determined whether or not the temperature of the battery 110 at the scheduled travel start time after the next V2X charging/discharging predicted in step S230 is lower than a threshold value.

According to the second modification as well, it is possible to suppress a large decrease in traveling performance during traveling after V2X charging, as in the above-described embodiment and the first modification.

Although not particularly shown, in the first modification, the temperature of the battery 110 at the time of the next V2X charging/discharging (during charging/discharging/after completion) is predicted, but the temperature of the battery 110 at the predicted travel start time after the next V2X charging/discharging may be predicted in the same manner as in the second modification.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A charging control device for a vehicle,
the vehicle comprising:
a battery that stores electric power for traveling;
a driving device that generates a driving force for the vehicle using electric power stored in the battery; and
a charging device that charges the battery with a power supply external to the vehicle,
the charging control device comprising:
a processor; and
a memory that stores a program to be executed by the processor, wherein
in accordance with the program, the processor
makes a charging plan for charging the battery by the charging device such that an SOC of the battery is equal to a target SOC, and
predicts a temperature of the battery when the battery is charged next time by the charging device, and
when the predicted temperature is low, the processor makes the charging plan by setting the target SOC higher than the target SOC when the predicted temperature is high.

2. The charging control device according to claim 1, wherein, when discharge power of the battery is limited to a predetermined value or less due to a decrease in the temperature, the processor makes the charging plan by setting the target SOC to a higher value.

3. The charging control device according to claim 2, wherein, when the discharge power is limited to the predetermined value or less due to a decrease in the temperature, the processor makes the charging plan by increasing the target SOC set by a user of the vehicle.

4. The charging control device according to claim 1, wherein the processor predicts the temperature of the battery during charging to be performed next time by the charging device.

5. The charging control device according to claim 1, wherein
the processor
makes the charging plan such that charging of the battery has been completed at a set travel start time of the vehicle, and
predicts the temperature, at the travel start time, of the battery after being charged next time by the charging device.

6. A charging system used for charging a vehicle,
the charging system comprising:
a charging facility to which the vehicle is to be connected; and
a charging control device for the vehicle,
the vehicle comprising:
a battery that stores electric power for traveling;
a driving device that generates a driving force for the vehicle using electric power stored in the battery; and
a charging device that charges the battery with electric power supplied from the charging facility, wherein
the charging control device
makes a charging plan for charging the battery by the charging facility such that an SOC of the battery is equal to a target SOC, and
predicts a temperature of the battery when the battery is charged next time by the charging facility,
when the predicted temperature is low, the charging control device makes the charging plan by setting the target SOC higher than the target SOC when the predicted temperature is high, and
the charging facility charges the battery in accordance with the charging plan made by the charging control device.
